(19) United States
(12) Patent Application Publication
(10) Pub. No.: US 2012/0254828 A1
(43) Pub. Date: Oct. 4, 2012

(54) Flexible Modeling Architecture For Management Systems

(75) Inventors: Subramaniam V. Aiylam, Shrewsbury, MA (US); John W. Wagner, Nashua, NH (US); Roger G. Desroches, II, Pelham, NH (US)

(73) Assignee: MODEL BASED MANAGEMENT TECHNOLOGIES, LLC, Nashua, NH (US)

(21) Appl. No.: 13/437,918

(22) Filed: Apr. 2, 2012

Related U.S. Application Data
(60) Provisional application No. 61/471,278, filed on Apr. 4, 2011.

(51) Int. Cl. G06F 9/44

(52) U.S. Cl. 717/104

(57) ABSTRACT

A flexible modeling architecture is described that allows multiple versions of entities of different types to be modeled in a structured fashion with different model sets, with a variety of functional models, each representing a different aspect of the system and allowing generation of any number of artifacts at build-time as well as run-time to result in rapid creation of consistent computer applications to manage concurrently a plurality of entities, dynamically adjusting to the version of metadata on each entity.

### CROSS-REFERENCE TO RELATED APPLICATIONS

This application claims the benefit of provisional patent application Ser. No. 61/471,278 filed 2011 Apr. 4 by the present inventors.

### BACKGROUND

1. Field

This application refers to software modeling of versioned entities controlled by a management system, with an emphasis on managing devices.

2. Prior Art

The following is a tabulation of some prior art that presently appears relevant:

### U.S. PATENT DOCUMENTS

| Pat. No. | Issue Date | Patentee |
|---|---|---|
| 6,904,588 | Jun. 07, 2005 | Reddy, et. al |
| 7,735,062 | Jun. 08, 2010 | Seabra e Melo, et. al. |
| US 2003/0101251 | May 29, 2003 | Keng Min Low |

### OTHER PUBLICATIONS

Jeffrey D. Case, et. al., A Simple Network Management Protocol (http://tools.ietforg/html/rfc1157)
Roberto Chinnici, et. al, Web Services Description Language (WSDL) Version 2.0 (http://www.w3.org/TR/wsd120/)

### BACKGROUND

Computer systems are used extensively to manage a variety of devices and/or machines. The act of management generally involves configuration and monitoring these devices. The data corresponding to these devices can be described such that the system has a formal definition of what is being managed (such a formal definition is often referred to as “metadata”).

This scenario is not restricted to computer systems that manage devices—it applies to managing virtually anything. In essence, any entity that is manipulated by a computer in any fashion can be considered to be a target of a management system—for example, a system managing financial information or health data or energy assets is also a management system, and modeling the system provides a number of benefits.

Most systems manage a large number of entities of various types, some of which may be dissimilar enough that they are completely different in nature. In addition, a number of versions of an entity are required to be managed concurrently. Consider the development lifecycle of a device being managed—typically, once a device is released, after some period of time it is almost inevitable that a new improved version of the device is released.

This new version will be different from the previous one—these differences may be major or minor in nature. In other words, there will be some number of modifications to the data required to model the new version. There needs to be a system by which it is possible to handle this differing metadata and manage both device versions in a consistent manner, without obscuring the fact that a certain device needs to be controlled slightly differently from another.

Over the years, there have been a number of formal definitions for different segments of applications. A couple of examples include:
MIB (Management Information Base) for SNMP (Simple Network Management Protocol)—based devices.
XSD (XML Schema Definition) and WSDL (Web Services Description Language) for web-based services.

Each of these are targeted towards a specific application or technology, and do not address the need for handling entities that have varied communications. It is desirable to have an internal modeling format that can be used consistently throughout the system, external modeling technologies should be converted to this format so that the rest of the system can interact with the models predictably.

There are a variety of other limitations with using just something like MIBs for SNMP. First and foremost, it is device-centric and is restricted to a specific communications protocol. Also, it restricts one to modeling just the data schema. There are other aspects to any system—such as security and operations; modeling these in MIBs is not a natural fit. Although something like WSDL does provide additional constructs such as functions, it does not provide an extensible means of introducing new perspectives to the system, including perspectives that refer to the data model.

With respect to patents listed, a number of requirements that define a flexible modeling architecture are not addressed. The patent by Reddy, et. al. is a system that allows a human user to visually view differences between different versions of a model and reconcile (or merge) this by analyzing them. This is a use case that is not relevant to a running system, which needs to manage/merge these variants automatically in order to generate code and other artifacts based on these. It also does not deal with organization of models in the form of “decorated” data models or with artifact generation.

The patent by Seabra e Melo et. al. discusses model storage in a central repository, but is related to visual models and similarly, involves merging models with user input. It does not consider conversion of native data models into a canonical internal format or how the models are structured to be used in a run-time environment. It also does not consider the use of build and run-time generation of artifacts to ease management.

The patent by Keng Min Low discusses the concept of modification of a base model by introducing business logic and customizations in the original model itself. This approach has a significant disadvantage—the base model should be kept in its original state since it acts as the formal interface definition between a device developer and the management system developer. This method does not account for the fact that the person managing the native data model and the one managing the other models are different and modifications to these have different life-cycles. Also, there is no concept of versioning built-in; thus a methodology to concurrently handle several versions of a model (and therefore, a device) does not exist. Additionally, it does not consider build-time versus run-time code generation, based upon versioned model differences.

### SUMMARY

In accordance with one embodiment, a flexible modeling architecture for a management system involves a formal textual description (or model) of the data being managed within the system in a simple, human- and machine-readable form. This is referred to as the formal or normative format. In a preferred embodiment, the eXtensible Markup Language (XML) format has proven to be one such form. This data model can be written by hand by a programmer or generated using computer software from some other format that is native to the entity or device being managed.

In the preferred embodiment, the modeling architecture provides the ability to “decorate” this data description with user-relevant information. Typically, this decoration is hand-written by a programmer and is stored in a separate file from any generated data model, so as to prevent loss of these changes upon regeneration. This allows a programmer to override definitions and behavior that are dictated by a native model.

In one embodiment, the modeling architecture supports the ability to generate source code from the data that can be used at build-time by a computer programmer to implement logic. In the preferred embodiment, source code in the Java programming language is used, but any other language (such as C++ or .Net) are also applicable. Providing source code allows a software developer to write business logic that is determined by the domain of the application.

The modeling architecture also supports the ability to generate object code from the data at run-time that can be used dynamically to implement logic and control various operations. In the preferred embodiment, byte-code for the Java language is generated. Run-time code-generation allows the system to be configured in a running system, without having to create and ship executable code and eases the upgrade process in the field for a deployed system.

In one preferred embodiment, the modeling architecture provides the ability to use modeled data at run-time to automatically generate communications with the entity being managed. This is particularly relevant when there is a native model that intrinsically describes the communications protocol. When conversion to the formal format takes place, this information is usually stored in the formal model as properties attached to class and/or attribute definitions.

The modeling architecture provides the ability to model new aspects (or perspectives) to the system in the form of other externally defined formal descriptions which reference the formal data definition. This is important, since the originators of the perspective and those of the data model are different. Most often, a device manufacturer is responsible for the data model, whereas an application developer is responsible for a functional model (such as user interface representation). To maintain separation of concerns, the architecture must be able to support being able to edit and maintain these models independently. These functional models allow the developer to drive components of the system, based upon these aspects—examples are of such systems are database persistence, graphical user interfaces, etc.

In the preferred embodiment, the modeling architecture supports the ability to handle concurrently multiple versions of the data, wherein the various versions are different from one another. Since a system can, at a given time, manage a number of entities (each of which may be running against a specific version of the data model), the architecture is highly version-aware. It allows keeping sets of models, with each set corresponding to a separate version. It allows merging all the versions internally into an aggregate to permit aspects of the system that span multiple versions. Also, this is true of all entity types; in other words, the architecture supports modeling across an infinite number of entity types, with each entity type supporting an infinite number of versions, limited only by the amount of resources available to the application.

### DRAWINGS—FIGURES

FIG. 1 shows the architecture of a flexible modeling system in terms of its various components and example output targets that can be derived from it.

FIG. 2 shows one possible layout of how the models are organized, based upon the plurality of versions for a given target (or device).

FIG. 3 shows one embodiment of how metadata obtained from these models are processed in order to generate computer code and drive communications with a device being managed.

FIG. 4 shows one mechanism by which source code can be generated from the data models to be used by programmers writing software.

FIG. 5 shows one mechanism by which object code can be generated from the data models at run-time to provide dynamic manipulation of metadata.

FIG. 6 shows one embodiment by which the use of a flexible modeling architecture permits management of persistent data in a relational database.

FIG. 7 shown the logic used to dynamically match the currently running version on a device with the best available metadata version resident on the management system.

FIG. 8 shows an embodiment of a Graphical User Interface representation of the same object for two different versions of metadata.

### DRAWINGS—REFERENCE NUMERALS

101. Data Definition Models (DDM/EDDM)
102. Configuration Model
103. Configuration User Interface
104. Database Model
105. Persistence-related Artifacts
106. Service Model
107. External API to System/Security
Controls
108. Statistics Model
109. Statistics Gathering and Graphing
110. Help Model
111. User Help/Documentation
201. Main Model XML File
202. Data Definition Model (DDM) XML
File (for Version 1.0)
203. Enhanced Data Definition Model
(EDDM) XML File (for Version 1.0)
204. Configuration GUI Model XML File
(for Version 1.0)
205. Alarm Model XML File (for Version
1.0)
206. Statistics Model XML File (for Version
1.0)
207. Database Model XML File (un-
versioned)
208. Service Model XML File (un-
versioned)
209. User-Defined Model File (un-
versioned)
301. Native Data Model
302. Model Conversion Program
303. Data Definition Model (DDM)
304. Enhanced Data Definition Model
(EDDM)
305. Code Generation Program
306. Generated Classes (source and object
code)
307. Device Communication Program
308. Device being managed
402. Build-time source code generator
403. Generated source code
502. Run-time byte-code generator
601. Object-Relational Mapping file
generator
602. Object-Relational Mapping Files
603. Object-Relational Mapping Program
801. Graphical User Interface example for
version 1.0
802. Graphical User Interface example for
version 1.1

### DETAILED DESCRIPTION

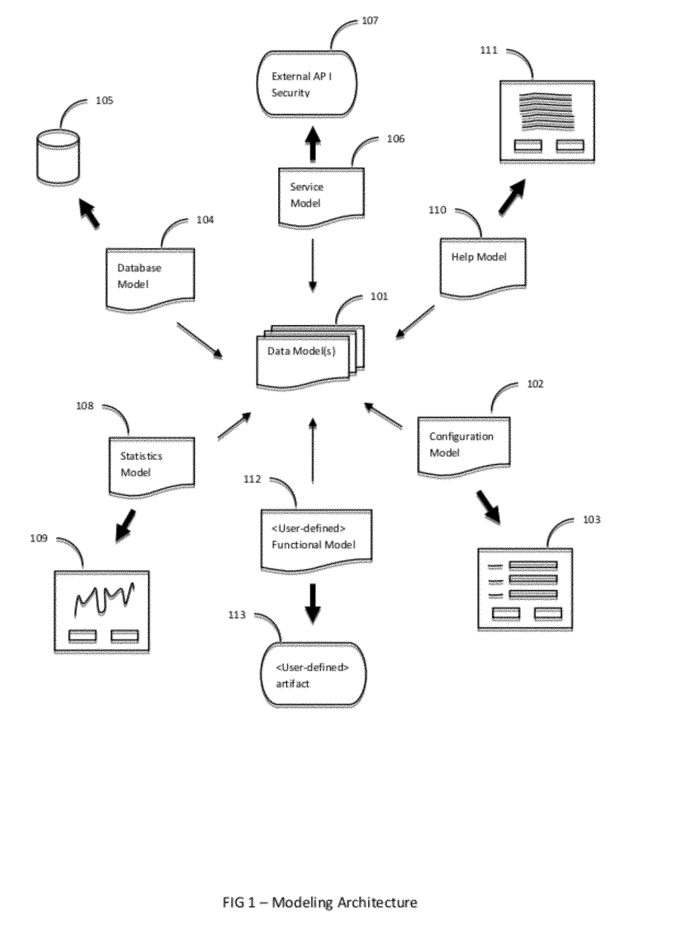

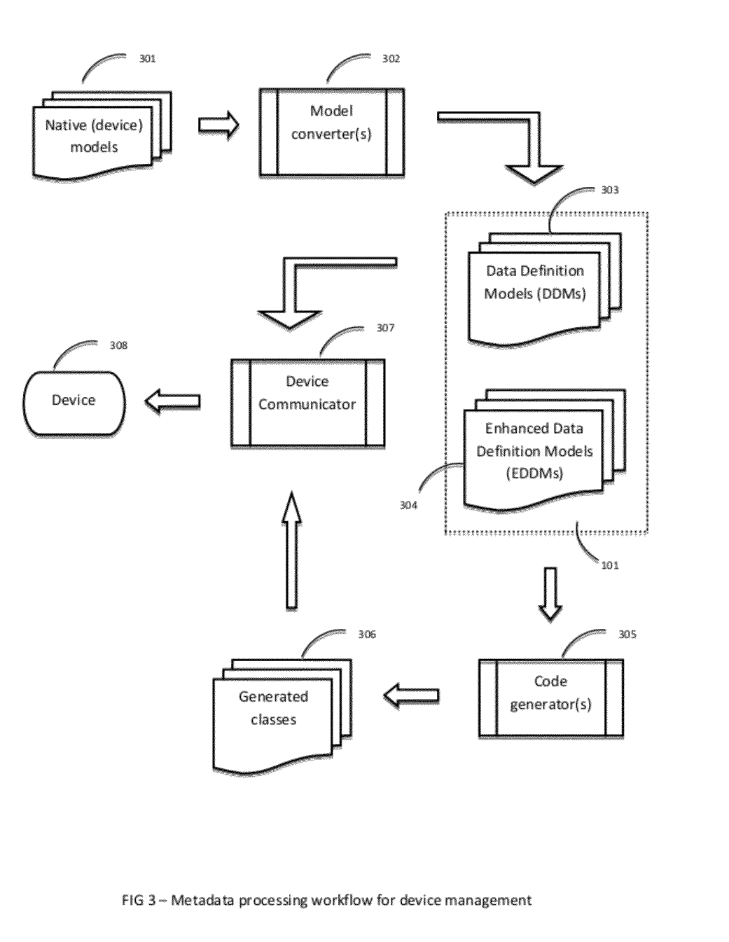

One embodiment of the architecture is shown in FIGS. 1 through 6. The central aspect of the architecture is the set of Data Model(s) 101, representing the entity being managed. The data model set consists of a plurality of model files, each file potentially generated from different sources.

One example of a source is the Native Device Model 301, which describes a device using a device-centric modeling language, such as MIB for SNMP. Native Device Model 301 is converted into a formal, normative definition of data. This conversion is performed by the Model Converter 302, which generates the resultant Data Definition Model (DDM) 303. Another example of a source is a hand-written model, which can describe new managed entities or modify entities within Data Definition Model 303. This hand-written model is called the Enhanced Data Definition Model 304. DDM 303 and EDDM 304 are referred to as the Data Model set 101.

For example, a snippet of Native Device Model 301 using the MIB format is shown below:

ipRouteEntry OBJECT-TYPE

| | |
|---|---|
| SYNTAX | IpRouteEntry |
| ACCESS | not-accessible |
| STATUS | mandatory |

| DESCRIPTION | |
|---|---|
| | ″A route to a particular destination.″ |
| INDEX | { ipRouteDest } |

::= { ipRouteTable 1 }

IpRouteEntry ::=

SEQUENCE {

ipRouteDest

IpAddress,

ipRouteIfIndex

INTEGER,

ipRouteMetric1

INTEGER,

ipRouteMetric2

INTEGER,

ipRouteMetric3

INTEGER,

ipRouteMetric4

INTEGER,

ipRouteNextHop

IpAddress,

ipRouteType

INTEGER,

ipRouteProto

INTEGER,

ipRouteAge

INTEGER,

ipRouteMask

IpAddress,

ipRouteInfo

OBJECT IDENTIFIER

}

ipRouteDest OBJECT-TYPE

| | |
|---|---|
| SYNTAX | IpAddress |
| ACCESS | read-write |
| STATUS | mandatory |

DESCRIPTION

″The destination IP address of this route. An
entry with a value of 0.0.0.0 is considered a
default route. Multiple routes to a single
destination can appear in the table, but access to
such multiple entries is dependent on the table-
access mechanisms defined by the network
management protocol in use.″

::= { ipRouteEntry 1 }

ipRouteIfIndex OBJECT-TYPE

| | |
|---|---|
| SYNTAX | INTEGER |
| ACCESS | read-write |
| STATUS | mandatory |

DESCRIPTION

″The index value which uniquely identifies the
local interface through which the next hop of this
route should be reached. The interface identified
by a particular value of this index is the same
interface as identified by the same value of
ifIndex.″

::= { ipRouteEntry 2 }

ipRouteMetric1 OBJECT-TYPE

| | |
|---|---|
| SYNTAX | INTEGER |
| ACCESS | read-write |
| STATUS | mandatory |

DESCRIPTION

″The primary routing metric for this route. The
semantics of this metric are determined by the
routing-protocol specified in the route's
ipRouteProto value. If this metric is not used,
its value should be set to −1.″

::= { ipRouteEntry 3 }

ipRouteMetric2 OBJECT-TYPE

| | |
|---|---|
| SYNTAX | INTEGER |
| ACCESS | read-write |
| STATUS | mandatory |

DESCRIPTION

″An alternate routing metric for this route. The
semantics of this metric are determined by the
routing-protocol specified in the route's
ipRouteProto value. If this metric is not used,
its value should be set to −1.″

::= { ipRouteEntry 4 }

ipRouteMetric3 OBJECT-TYPE

| | |
|---|---|
| SYNTAX | INTEGER |
| ACCESS | read-write |
| STATUS | mandatory |

DESCRIPTION

″An alternate routing metric for this route. The
semantics of this metric are determined by the
routing-protocol specified in the route's
ipRouteProto value. If this metric is not used,
its value should be set to −1.″

::= { ipRouteEntry 5 }

ipRouteMetric4 OBJECT-TYPE

| | |
|---|---|
| SYNTAX | INTEGER |
| ACCESS | read-write |
| STATUS | mandatory |

DESCRIPTION

″An alternate routing metric for this route. The
semantics of this metric are determined by the
routing-protocol specified in the route's
ipRouteProto value. If this metric is not used,
its value should be set to −1.″

::= { ipRouteEntry 6 }

ipRouteNextHop OBJECT-TYPE

| | |
|---|---|
| SYNTAX | IpAddress |
| ACCESS | read-write |
| STATUS | mandatory |

DESCRIPTION

″The IP address of the next hop of this route.
(In the case of a route bound to an interface
which is realized via a broadcast media, the value
of this field is the agent's IP address on that
interface.)″

::= { ipRouteEntry 7 }

ipRouteType OBJECT-TYPE

| | |
|---|---|
| SYNTAX | INTEGER { |

| other(1), | -- none of the following |
|---|---|
| invalid(2), | -- an invalidated route |
| | -- route to directly |
| direct(3), | -- connected (sub-)network |
| | -- route to a non-local |
| indirect(4) | -- host/network/sub-network |

}

| | |
|---|---|
| ACCESS | read-write |
| STATUS | mandatory |

DESCRIPTION

″The type of route. Note that the values
direct(3) and indirect(4) refer to the notion of
direct and indirect routing in the IP
architecture.
Setting this object to the value invalid(2) has
the effect of invalidating the corresponding entry
in the ipRouteTable object. That is, it
effectively dissasociates the destination
identified with said entry from the route
identified with said entry. It is an
implementation-specific matter as to whether the
agent removes an invalidated entry from the table.
Accordingly, management stations must be prepared
to receive tabular information from agents that
corresponds to entries not currently in use.
Proper interpretation of such entries requires
examination of the relevant ipRouteType object.″

::= { ipRouteEntry 8 }

ipRouteProto OBJECT-TYPE

| | |
|---|---|
| SYNTAX | INTEGER { |

| other(1), | -- none of the following |
|---|---|
| | -- non-protocol information, |
| | -- e.g., manually configured |
| local(2), | -- entries |
| | -- set via a network |
| netmgmt(3), | -- management protocol |
| | -- obtained via ICMP, |
| icmp(4), | -- e.g., Redirect |

-- the remaining, values are
-- all gateway routing
-- protocols

egp(5),
ggp(6),
hello(7),
rip(8),
is-is(9),
es-is(10),
ciscoIgrp(11),
bbnSpfIgp(12),
ospf(13),
bgp(14)

}

| | |
|---|---|
| ACCESS | read-only |
| STATUS | mandatory |

DESCRIPTION

″The routing mechanism via which this route was
learned. Inclusion of values for gateway routing
protocols is not intended to imply that hosts
should support those protocols.″

::= { ipRouteEntry 9 }

ipRouteAge OBJECT-TYPE

| | |
|---|---|
| SYNTAX | INTEGER |
| ACCESS | read-write |
| STATUS | mandatory |

DESCRIPTION

″The number of seconds since this route was last
updated or otherwise determined to be correct.
Note that no semantics of ‘too old′ can be implied
except through knowledge of the routing protocol
by which the route was learned.″

::= { ipRouteEntry 10 }

ipRouteMask OBJECT-TYPE

| | |
|---|---|
| SYNTAX | IpAddress |
| ACCESS | read-write |
| STATUS | mandatory |

DESCRIPTION

″Indicate the mask to be logical-ANDed with the
destination address before being compared to the
value in the ipRouteDest field. For those systems
that do not support arbitrary subnet masks, an
agent constructs the value of the ipRouteMask by
determining whether the value of the correspondent
ipRouteDest field belong to a class-A, B, or C
network, and then using one of:

| | |
|---|---|
| mask | network |
| 255.0.0.0 | class-A |
| 255.255.0.0 | class-B |
| 255.255.255.0 | class-C |

If the value of the ipRouteDest is 0.0.0.0 (a
default route), then the mask value is also
0.0.0.0. It should be noted that all IP routing
subsystems implicitly use this mechanism.″

::= { ipRouteEntry 11 }

A snippet of DDM 303 generated from the above MIB snippet is shown below:

```
    <enumeration name=“IpRouteEntry_ipRouteType_Enum”>
      <literal name=“other”>
        <prop name=“snmp.value” value=“1” />
      </literal>
      <literal name=“invalid”>
        <prop name=“snmp.value” value=“2” />
      </literal>
      <literal name=“direct”>
        <prop name=“snmp.value” value=“3” />
      </literal>
      <literal name=“indirect”>
        <prop name=“snmp.value” value=“4” />
      </literal>
    </enumeration>
    <enumeration name=“IpRouteEntry_ipRouteProto_Enum”>
      <literal name=“other”>
        <prop name=“snmp.value” value=“1” />
      </literal>
      <literal name=“local”>
        <prop name=“snmp.value” value=“2” />
      </literal>
      <literal name=“netmgmt”>
        <prop name=“snmp.value” value=“3” />
      </literal>
      <literal name=“icmp”>
        <prop name=“snmp.value” value=“4” />
      </literal>
      <literal name=“egp”>
        <prop name=“snmp.value” value=“5” />
      </literal>
      <literal name=“ggp”>
        <prop name=“snmp.value” value=“6” />
      </literal>
      <literal name=“hello”>
        <prop name=“snmp.value” value=“7” />
      </literal>
      <literal name=“rip”>
        <prop name=“snmp.value” value=“8” />
      </literal>
      <literal name=“is-is”>
        <prop name=“snmp.value” value=“9” />
      </literal>
      <literal name=“es-is”>
        <prop name=“snmp.value” value=“10” />
      </literal>
      <literal name=“ciscoIgrp”>
        <prop name=“snmp.value” value=“11” />
      </literal>
      <literal name=“bbnSpfIgp”>
        <prop name=“snmp.value” value=“12” />
      </literal>
      <literal name=“ospf”>
        <prop name=“snmp.value” value=“13” />
      </literal>
      <literal name=“bgp”>
        <prop name=“snmp.value” value=“14” />
      </literal>
    </enumeration>
    <class name=“IpRouteEntry” family=“config”
javaClass=“IpRouteEntry”
parentClass=“IpRouteTable” description=“A route to a particular
destination.” keySet=“ipRouteDest”>
      <attribute name=“ipRouteDest” type=“string”
description=“The destination IP address of this route.
An&#xA;entry with a value of 0.0.0.0 is considered a&#xA;default
route. Multiple routes to a single&#xA;destination can appear
in the table, but access to&#xA;such multiple entries is
dependent on the table-&#xA;access mechanisms defined by the
network&#xA;management protocol in use.”>
        <prop name=“snmp.type” value=“OCTET STRING” />
        <prop name=“snmp.oid” value=“1.3.6.1.2.1.4.21.1.1” />
      </attribute>
      <attribute name=“ipRouteIfIndex” type=“integer”
description=“The index value which uniquely identifies
the&#xA;local interface through which the next hop of
this&#xA;route should be reached. The interface
identified&#xA;by a particular value of this index is the
same&#xA;interface as identified by the same value
of&#xA;ifIndex.”>
        <prop name=“snmp.type” value=“INTEGER” />
        <prop name=“snmp.oid” value=“1.3.6.1.2.1.4.21.1.2” />
      </attribute>
      <attribute name=“ipRouteMetric1” type=“integer”
description=“The primary routing metric for this route.
The&#xA;semantics of this metric are determined by
the&#xA;routing-protocol specified in the
route's&#xA;ipRouteProto value. If this metric is not
used,&#xA;its value should be set to −1.”>
        <prop name=“snmp.type” value=“INTEGER” />
        <prop name=“snmp.oid” value=“1.3.6.1.2.1.4.21.1.3” />
      </attribute>
      <attribute name=“ipRouteMetric2” type=“integer”
description=“An alternate routing metric for this route.
The&#xA;semantics of this metric are determined by
the&#xA;routing-protocol specified in the
route's&#xA;ipRouteProto value. If this metric is not
used,&#xA;its value should be set to −1.”>
        <prop name=“snmp.type” value=“INTEGER” />
        <prop name=“snmp.oid” value=“1.3.6.1.2.1.4.21.1.4” />
      </attribute>
      <attribute name=“ipRouteMetric3” type=“integer”
description=“An alternate routing metric for this route.
The&#xA;semantics of this metric are determined by
the&#xA;routing-protocol specified in the
route's&#xA;ipRouteProto value. If this metric is not
used,&#xA;its value should be set to −1.”>
        <prop name=“snmp.type” value=“INTEGER” />
        <prop name=“snmp.oid” value=“1.3.6.1.2.1.4.21.1.5” />
      </attribute>
      <attribute name=“ipRouteMetric4” type=“integer”
description=“An alternate routing metric for this route.
The&#xA;semantics of this metric are determined by
the&#xA;routing-protocol specified-in the
route's&#xA;ipRouteProto value. If this metric is not
used,&#xA;its value should be set to −1.”>
        <prop name=“snmp.type” value=“INTEGER” />
        <prop name=“snmp.oid” value=“1.3.6.1.2.1.4.21.1.6” />
      </attribute>
      <attribute name=“ipRouteNextHop” type=“string”
description=“The IP address of the next hop of this
route.&#xA;(In the case of a route bound to an
interface&#xA;which is realized via a broadcast media, the
value&#xA;of this field is the agent's IP address on
that&#xA;interface.)”>
        <prop name=“snmp.type” value=“OCTET STRING” />
        <prop name=“snmp.oid” value=“1.3.6.1.2.1.4.21.1.7” />
      </attribute>
      <attribute name=“ipRouteType”
type=“IpRouteEntry_ipRouteType_Enum” description=“The type of
route. Note that the values&#xA;direct(3) and indirect(4) refer
to the notion of&#xA;direct and indirect routing in the
IP&#xA;architecture.&#xA;&#xA;Setting this object to the value
invalid(2) has&#xA;the effect of invalidating the corresponding
entry&#xA;in the ipRouteTable object. That is,
it&#xA;effectively dissasociates the destination&#xA;identified
with said entry from the route&#xA;identified with said entry.
It is an&#xA;implementation-specific matter as to whether
the&#xA;agent removes an invalidated entry from the
table.&#xA;Accordingly, management stations must be
prepared&#xA;to receive tabular information from agents
that&#xA;corresponds to entries not currently in use.&#xA;Proper
interpretation of such entries requires&#xA;examination of the
relevant ipRouteType object.”>
        <prop name=“snmp.moniker”
value=“IpRouteEntry_ipRouteType_Enum” />
        <prop name=“snmp.type” value=“INTEGER” />
        <prop name=“snmp.oid” value=“1.3.6.1.2.1.4.21.1.8” />
      </attribute>
      <attribute name=“ipRouteProto”
type=“IpRouteEntry_ipRouteProto_Enum” description=“The routing
mechanism via which this route was&#xA;learned. Inclusion of
values for gateway routing&#xA;protocols is not intended to
imply that hosts&#xA;should support those protocols.”
readOnly=“true”>
        <prop name=“snmp.moniker”
value=“IpRouteEntry_ipRouteProto_Enum” />
        <prop name=“snmp.type” value=“INTEGER” />
        <prop name=“snmp.oid” value=“1.3.6.1.2.1.4.21.1.9” />
      </attribute>
      <attribute name=“ipRouteAge” type=“integer”
description=“The number of seconds since this route was
last&#xA;updated or otherwise determined to be correct.&#xA;Note
that no semantics of ‘too old’ can be implied&#xA;except through
knowledge of the routing protocol&#xA;by which the route was
learned.”>
        <prop name=“snmp.type” value=“INTEGER” />
        <prop name=“snmp.oid” value=“1.3.6.1.2.1.4.21.1.10” />
      </attribute>
      <attribute name=“ipRouteMask” type=“string”
description=“Indicate the mask to be logical-ANDed with
the&#xA;destination address before being compared to
the&#xA;value in the ipRouteDest field. For those
systems&#xA;that do not support arbitrary subnet masks,
an&#xA;agent constructs the value of the ipRouteMask
by&#xA;determining whether the value of the
correspondent&#xA;ipRouteDest field belong to a class-A, B, or
C&#xA;network, and then using one of:&#xA;&#xA; mask
network&#xA; 255.0.0.0 class-A&#xA; 255.255.0.0
class-B&#xA; 255.255.255.0  class-C&#xA;If the value of the
ipRouteDest is 0.0.0.0 (a&#xA;default route), then the mask
value is also&#xA;0.0.0.0. It should be noted that all IP
routing&#xA;subsystems implicitly use this mechanism.”>
        <prop name=“snmp.type” value=“OCTET STRING” />
        <prop name=“snmp.oid” value=“1.3.6.1.2.1.4.21.1.11” />
      </attribute>
```

In general, the information within Data Model 101 is referred to as metadata, i.e. data about data. In one embodiment, in an object-oriented system, Data Model 101 consists of the various classes that are relevant to the entity being managed. Each class, in turn, consists of a number of attributes. An attribute can be a simple attribute (such as a number) or it could represent a relationship to another class. Constraints can be defined on an attribute (such as a range restriction on a number). All constituents of Data Model 101 can be “decorated”—i.e. user or system properties can be defined that attach to the constituent. Such properties are also considered part of metadata and are shown as the “prop” XML element in the above snippet.

A snippet of EDDM 304 that refers to the IpRouteEntry class defined in DDM 303 and introducing a range constraint on attribute ipRouteMetric3 is shown below as an example:

```
<class ref=“IpRouteEntry” />
  <attribute name=“ipRouteMetric3”/>
    <constraint type=“range” value=“0 255” />
  </attribute>
</class>
```

Other models can be written, in terms of Data Model 101 such that they define a certain perspective of the system. Such a model is called a Functional Model 112. Each Functional Model 112 can use Data Model 101 to generate any relevant Artifact 113 needed to implement functionality for that perspective. A number of actual functional models are shown in FIG. 1; the modeling architecture does not restrict functional models to these.

The Database Model 104 represents information about how to persist entities modeled in Data Model 101 in a Relational Database 105. It can include information about database tables, mapping attributes to columns in a table as well as indexing information. This model can be used to drive the mechanism that reads data from and writes data to a relational database.

The Configuration Model 102 describes how the data defined in Data Model 101 can be configured using a Graphical User Interface (such as a Web browser). It can contain information on how a class maps to a screen and how each attribute is displayed. It can provide layout information that drives how a screen is presented. It can contain user-friendly labels and tool-tips to guide a user. It can specify how data is accepted and perform validation of user input. Eventually, it drives the Graphical User Interface 103, which is responsible for user interaction.

An example of this is shown by a snippet of Configuration Model 102 below. This indicates that the Graphical User interface should display a table of IpRouteEntry objects with the title “IP Routes”. The label against the field displaying the ipRouteDest attribute should be called “Route Destination”.

```
<classGUI class=“IpRouteEntry” >
    <table title=“IP Routes” />
    <field name=“ipRouteDest” label=“Route Destination” />
</classGUI>
```

The Statistics Model 108 defines which classes in Data Model 101 contain statistical counters. This information can be used to drive a statistics collection system, which periodically collects information about these classes and stores them. The statistics system can then perform business analytics and display historical data in various forms, such as two-dimensional graph 109.

The Service Model 106 represents the API (Application Programming Interface) to and security definition within the system. It defines what functions or methods are accessible to an external system that needs to exercise control. Any number of “services” can be defined; every service has some number of method definitions. Each method will define the input and output parameters and their type. The service model can also define a set of permissions in the system, as well as what permissions are required to access specific methods. Service Model 106 can be used to generate external APIs 107 that conform to standard specifications, such as Simple Object Access Protocol (SOAP).

The Help Model 110 defines a set of tags, each of which corresponds to a topic in a Help System. A Help system is used to provide users with context-sensitive help information and guide them about a specific topic. Help Model 110 refers to Data Model 101 such that it can relate to help on specific classes in Data Model 101. Using these references, a Help System can present the appropriate Help page 111 to the user at run-time.

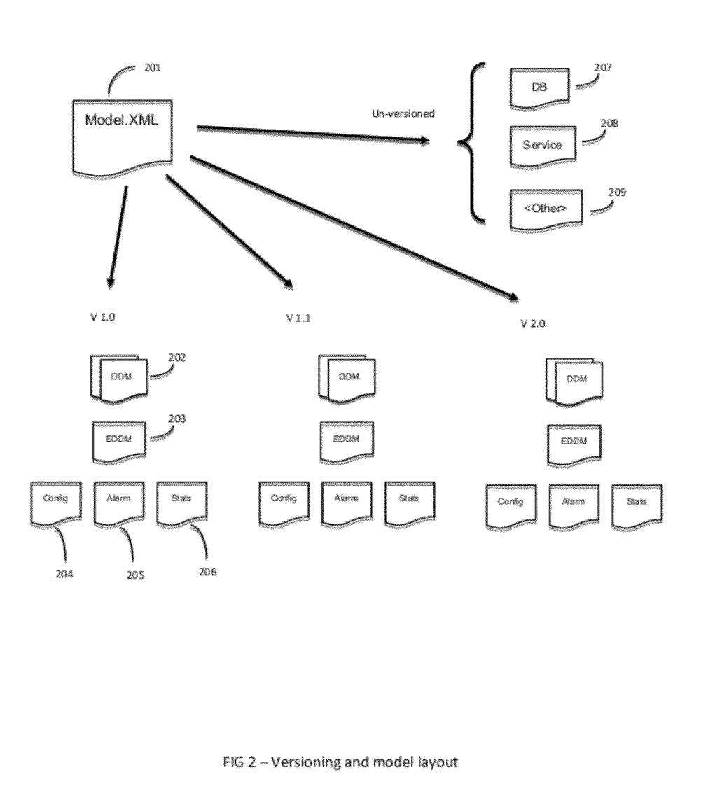

Since, over time, all managed entities evolve, the modeling architecture must support the concept of versions. If FIG. 2 shows one embodiment of how a system can organize and support multiple versions of the same managed entity. The idea is to have a grouping of all model files pertaining to each version maintained independently. The model files for each version are kept under a single directory. In this embodiment, all models are represented in XML (Extensible Markup Language) formatted text files.

Under the Version 1.0 directory (V1.0) are the files containing DDM 202 and EDDM 203—the data models for the managed entity with Version 1.0. The directory also contains all the other version-specific model files—the Configuration Model file 204, the Alarm Model file 205 and the Statistics Model file 206. Any other model files that are dependent upon the specific version would also be stored here.

The V1.1 and V2.0 directories are similar to the V1.0 directory, holding model files for the 1.1 and 2.0 versions respectively. Internally, the system aggregates the data models from all these versions and maintains their union—this is referred to as the un-versioned model. Some functional models operate upon this aggregated union and are maintained in a separate directory. The Database Model file 207, Service Model file 208 and <Other> Model file 209 are examples of un-versioned functional models.

The entire structure is described in the top-level Model XML file 201. This file explicitly enumerates all the versions and the model files contained in each version. Model XML file 201 is the starting point for computer programs that need to analyze the comprehensive model for each managed entity. In a system that manages multiple entities, this entire structure, starting with Model XML file 201 is repeated for each entity.

An example of Model XML file 201 is shown below:

```
<?xml version=“1.0”?>
<moduleModel name=“SnmpDevice” displayName=“MIB-II Device”
xmlSchemaVersion=“1.0” description=“Snmp-based MIB-II Device”>
  <prop name=“moduleDefinitionClass”
value=“com.centeredlogic.snmpdevice.SnmpDeviceModuleDef”/>
  <!-- this section contains information on all model files
used for this module -->
  <models>
    <!-- These are the definitions that are systemic in
nature, so they are valid for all versions (as well as the
unversioned case -->
    <include name=“global”>
      <enhancedDataModel file=“globalEDDM.xml” />
      <functionalModels>
        <functionalModel type=“hibernate”
file=“globalDBModel.xml”
processor=“com.centeredlogic.metadata.hibernate.HibernateModel” />
      </functionalModels>
    </include>
    <versions>
      <version releaseNumber=“1.0” description=“first
release”>
        <dataModels>
          <file
processor=“com.centeredlogic.ecx.metadata.snmpDataModel.SnmpData
ModelProcessor”>DDM.xml</file>
        </dataModels>
        <enhancedDataModels>
          <file>EDDM.xml</file>
        </enhancedDataModels>
        <functionalModels>
          <functionalModel type=“gui”
file=“ConfigGUIModel.xml”
processor=“com.centeredlogic.ecx.config.metadata.GuiModel”/>
        </functionalModels>
      </version>
      <version releaseNumber=“1.1” description=“first
release”>
        <dataModels>
          <file
processor=“com.centeredlogic.ecx.metadata.snmpDataModel.SnmpData
ModelProcessor”>DDM.xml</file>
        </dataModels>
        <enhancedDataModels>
          <file>EDDM.xml</file>
        </enhancedDataModels>
        <functionalModels>
          <functionalModel type=“gui”
file=“ConfigGUIModel.xml”
processor=“com.centeredlogic.ecx.config.metadata.GuiModel”/>
        </functionalModels>
      </version>
    </versions>
    <unversioned>
      <functionalModels>
        <functionalModel type=“hibernate”
file=“HibernateModel.xml”
processor=“com.centeredlogic.metadata.hibernate.HibernateModel” />
        <functionalModel type=“services”
file=“ServiceModel.xml”
processor=“com.centeredlogic.metadata.services.ServiceModel” />
      </functionalModels>
    </unversioned>
  </models>
</moduleModel>
```

Another advantage of this organization is the ability to rapidly introduce new versions of a managed entity to an existing running system. Also, over time, as managed entities reach their end-of-life, removal of a version can be easily controlled by just removing the relevant directory structure.

### Handling Multiple Versions

One embodiment of how versioning can be implemented is described below. Let us assume that version 1.1 of the SNMP model contains two additional attributes in the IpRouteEntry class as shown below:

```
IpRouteEntry ::=
  SEQUENCE {
    ... previously existing attributes ...
    ipRouteMetric5
```

INTEGER,

ipRouteInfo

OBJECT IDENTIFIER

}
ipRouteMetric5 OBJECT-TYPE

| | |
|---|---|
| SYNTAX | INTEGER |
| ACCESS | read-write |
| STATUS | mandatory |

DESCRIPTION

“An alternate routing metric for this route. The
semantics of this metric are determined by the
routing-protocol specified in the route's
ipRouteProto value. If this metric is not used,
its value should be set to −1.”

::= { ipRouteEntry 12 }
ipRouteInfo OBJECT-TYPE

| | |
|---|---|
| SYNTAX | OBJECT IDENTIFIER |
| ACCESS | read-only |
| STATUS | mandatory |

DESCRIPTION

“A reference to MIB definitions specific to the
particular routing protocol which is responsible
for this route, as determined by the value
specified in the route's ipRouteProto value. If
this information is not present, its value should
be set to the OBJECT IDENTIFIER { 0 0 }, which is
a syntatically valid object identifier, and any
conformant implementation of ASN.1 and BER must be
able to generate and recognize this value.”

::= { ipRouteEntry 13 }

The version 1.1 DDM generated for the IpRouteEntry class will now contain two additional members:

```
  <class name=“IpRouteEntry” family=“config”
javaClass=“IpRouteEntry”
parentClass=“IpRouteTable” description=“A route to a particular
destination.” keySet=“ipRouteDest”>
    ... previously existing attributes ...
    <attribute name=“ipRouteMetric5” type=“integer”
description=“An alternate routing metric for this route.
The&#xA;semantics of this metric are determined by
the&#xA;routing-protocol specified in the
route's&#xA;ipRouteProto value. If this metric is not
used,&#xA;its value should be set to −1.”>
      <prop name=“snmp.type” value=“INTEGER” />
      <prop name=“snmp.oid” value=“1.3.6.1.2.1.4.21.1.12” />
    </attribute>
    <attribute name=“ipRouteInfo” type=“string” description=“A
reference to MIB definitions specific to the&#xA;particular
routing protocol which is responsible&#xA;for this route, as
determined by the value&#xA;specified in the route's
ipRouteProto value. If&#xA;this information is not present, its
value should&#xA;be set to the OBJECT IDENTIFIER { 0 0 }, which
is&#xA;a syntatically valid object identifier, and
any&#xA;conformant implementation of ASN.1 and BER must
be&#xA;able to generate and recognize this value.”
readOnly=“true”>
      <prop name=“snmp.type” value=“OBJECT IDENTIFIER” />
      <prop name=“snmp.oid” value=“1.3.6.1.2.1.4.21.1.13” />
    </attribute>
    <prop name=“snmp.oid” value=“1.3.6.1.2.1.4.21.1” />
  </class>
```

When the data models of both versions are processed, a un-versioned model in computed, containing the union of Data models from both versions. Certain artifacts are generated as described in the Operation section below, some based upon the versioned data model and other based on the un-versioned model. In one embodiment, the Build-time Source code-Generator 402 operates upon the un-versioned model to generate Java source, a snippet of which is shown below. Note that this includes the attributes ipRouteMetric5 and ipRouteInfo, which are introduced in version 1.1.

```
public class IpRouteEntry ...
{
  public java.lang.String getIpRouteDest( )
  {
    ... generated code goes here ...
  }
  public void setIpRouteDest(java.lang.String p_ipRouteDest)
  {
    ... generated code goes here ...
  }
  public java.lang.Integer getIpRouteIfIndex( )
  {
    ... generated code goes here ...
  }
  public void setIpRouteIfIndex(java.lang.Integer
p_ipRouteIfIndex)
  {
    ... generated code goes here ...
  }
  public java.lang.Integer getIpRouteMetric1( )
  {
    ... generated code goes here ...
  }
  public void setIpRouteMetric1(java.lang.Integer
p_ipRouteMetric1)
  {
    ... generated code goes here ...
  }
  public java.lang.Integer getIpRouteMetric2( )
  {
    ... generated code goes here ...
  }
  public void setIpRouteMetric2(java.lang.Integer
p_ipRouteMetric2)
  {
    ... generated code goes here ...
  }
  public java.lang.Integer getIpRouteMetric3( )
  {
    ... generated code goes here ...
  }
  public void setIpRouteMetric3(java.lang.Integer
p_ipRouteMetric3)
  {
    ... generated code goes here ...
  }
  public java.lang.Integer getIpRouteMetric4( )
  {
    ... generated code goes here ...
  }
  public void setIpRouteMetric4(java.lang.Integer
p_ipRouteMetric4)
  {
    ... generated code goes here ...
  }
  public java.lang.String getIpRouteNextHop( )
  {
    ... generated code goes here ...
  }
  public void setIpRouteNextHop(java.lang.String
p_ipRouteNextHop)
  {
    ... generated code goes here ...
  }
  public java.lang.String getIpRouteType( )
  {
    ... generated code goes here ...
  }
  public void setIpRouteType(java.lang.String p_ipRouteType)
  {
    ... generated code goes here ...
  }
  public java.lang.String getIpRouteProto( )
  {
    ... generated code goes here ...
  }
  public void setIpRouteProto(java.lang.String p_ipRouteProto)
  {
    ... generated code goes here ...
  }
  public java.lang.Integer getIpRouteAge( )
  {
    ... generated code goes here ...
  }
  public void setIpRouteAge(java.lang.Integer p_ipRouteAge)
  {
    ... generated code goes here ...
  }
  public java.lang.String getIpRouteMask( )
  {
    ... generated code goes here ...
  }
  public void setIpRouteMask(java.lang.String p_ipRouteMask)
  {
    ... generated code goes here ...
  }
  public java.lang.Integer getIpRouteMetric5( )
  {
    ... generated code goes here ...
  }
  public void setIpRouteMetric5(java.lang.Integer
p_ipRouteMetric5)
  {
    ... generated code goes here ...
  }
  public java.lang.String getIpRouteInfo( )
  {
    ... generated code goes here ...
  }
  public void setIpRouteInfo(java.lang.String p_ipRouteInfo)
  {
    ... generated code goes here ...
  }
}
```

Two snippets from the Configuration Model 102 are shown for versions 1.0 and 1.1 respectively. These models are different from one version to another, as can be seen from the fact that the version 1.1 configuration model refers to the ipRouteMetric5 attribute, which does not exist in the version 1.0 model.

The snippet from Configuration Model 102 for version 1.0:

```
<classGUI class=“IpRouteEntry” >
    <table title=“IP Routes” />
    <field name=“ipRouteDest” label=“Route Destination” />
    <field name=“ipRouteNextHop” label=“Next Hop” />
</classGUI>
```

The snippet from Configuration Model 102 for version 1.1:

```
<classGUI class=“IpRouteEntry” >
    <table title=“IP Routes” />
    <field name=“ipRouteDest” label=“Route Destination” />
    <field name=“ipRouteNextHop” label=“Next Hop” />
    <field name=“ipRouteMetric5” label=“Route Metric 5” />
  </classGUI>
```

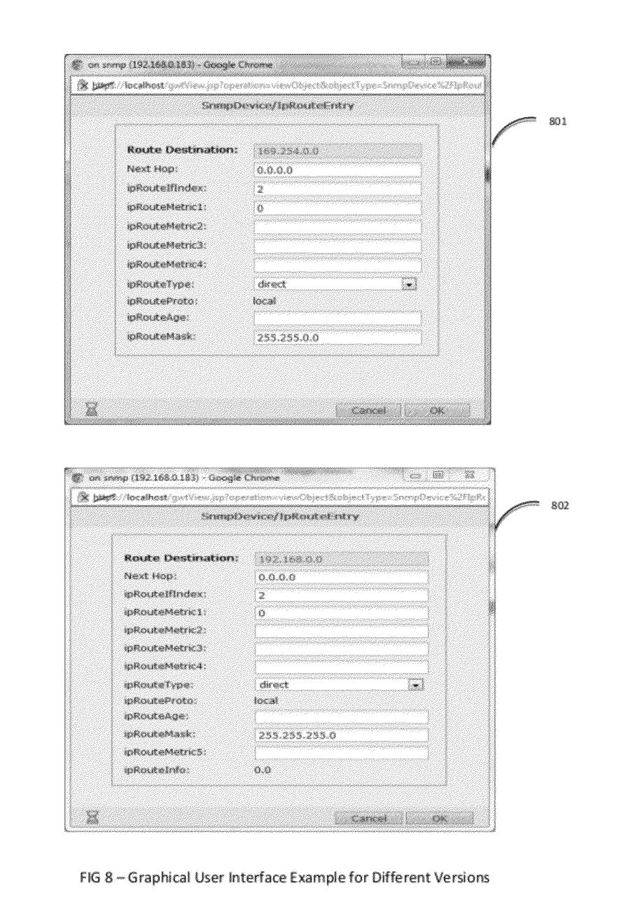

One embodiment of a Graphical User Interface (running in a Web browser) for each version is shown in FIG. 8. The Version 1.0 Graphical User Interface 801 does not contain any information about the extra attributes introduced in version 1.1, whereas the Version 1.1 Graphical User Interface 802 shows these attributes. Depending upon the current version running on a specific device, either Graphical User Interface 801 or 802 is appropriately presented to the user.

Management systems are often used to manage different types of entities (or devices). In many cases, the entities being managed have no relationship with each other at all and can be entirely disparate. A flexible system should support introduction of completely new entity types to be introduced at any point in the software development cycle without impacting the operation of managing other entity types.

Thus, for each entity or device type, there will be a complete set of model files as described in FIG. 2. Each entity type being managed will contain a Model XML file 201 along with the complete directory structure of related model files for all versions of that entity. Each entity type is also referred to as a module, as indicated in the listing of Model Xml file 201.

### Operation

In this embodiment, a developer starts with the set of native models 301, if they exist for a given entity to be managed. As an example, we may consider a device that uses Simple Network Management Protocol (SNMP) as the communications protocol. Such a device would use a Management Information Base (MIB) to represent the various classes required to manage it.

Using the MIB files as Native Model 301, the Model Converter Program 302 will, parse Native Model 301 and generate one or more Data Definition Model 303 files. These files will be an exact one-to-one correspondence with Native Model 301 and will not be modified by a developer. This is important because, during the development phase, Native Model 301 will undergo modifications and it will become necessary to regenerate Data Definition Model 303. Any human-induced modifications of DDM 303 will be lost upon regeneration. DDM 303 will also contain decorations in the form of properties on classes and attributes that will allow Device Communicator 307 to drive communications with Device 308. These communications will be based upon the specific version of Device 308 as modeled.

This procedure can be used for other types of Native Model 301. What changes in this case is Model Conversion Program 302—a different Model Conversion Program can be written to convert Native Model 301 into the resultant DDM 303. The format of DDM 303 is normative, thus allowing the system using this architecture to work off a formal, well-defined format regardless of the format of Native Model 301.

Once the DDM 303 has been generated, a software programmer or developer can create the Enhanced Data Definition Model 304 files. EDDM 304 may contain additional metadata relating to the device that does not derive from Native Model 301 (and hence is not found in DDM 303). It may also modify and/or delete part of the definitions found in DDM 303. This allows a developer to enhance the auto-generated DDM in order to achieve more fine-grained control of device metadata. In one embodiment, a default EDDM that had place-holders without any enhancements may be auto-generated by Model Conversion Program 302 to ease this task.

At this point, the data model set for a specific version of a target entity is available. The software developer now creates all the version-dependent models files that refer to Data Model 101. These could include the Configuration Model 102, Statistics Model 108, Alarm Model 205 and any other User Defined Functional Model 112 that are based upon this specific version of the target. In this embodiment, these models are created by hand and allow the user to describe various perspectives of the system. Version-dependent models are also called versioned models.

Once all version-dependent models have been defined, the version-independent model files are created. These are referred to as Un-versioned Models. These models operate on the entire set of definitions contributed by each versioned model. The un-versioned model is effectively the union of all versioned models. These could include creating the files for Database Model 207, Service Model 208 and the <Other> Model 209, which represents a user-defined model.

In this embodiment in an object-oriented system, a un-versioned class contains all the attributed defined in every versioned model that defines the class. Database Model 207 can provide persistence information by referring to any or all of these attributes. Service Model 208 can define services and methods that may pass in or return parameters that can refer to any or all of the classes defined in any versioned model.

Once this entire structure has been created and defined in the main Model XML file 201, a developer will run all the generators that work on the various models. Some generators create artifacts that can be used during the software development cycle while some create artifacts that are used at application run-time.

This process is repeated for each entity type being managed by the system, since every entity type has its own set of versioned and un-versioned models that may require generation of relevant artifacts.

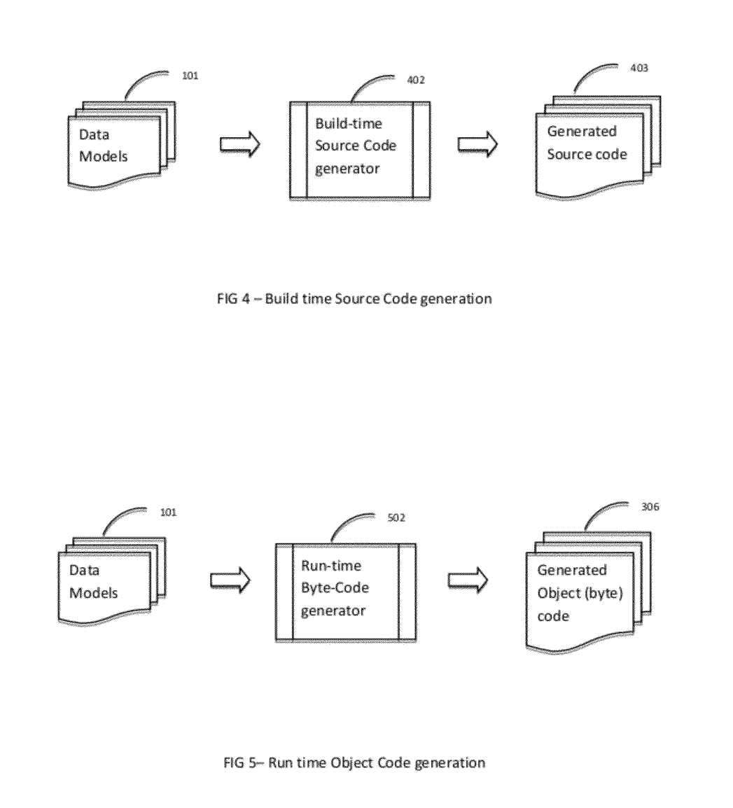

FIG. 4 shows how Data Model set 101 (comprising of DDM 303 and EDDM 304) are used to generate source code that represents the classes in the model. As shown in FIG. 4, Build-time source code generator 402 generates source code 403. The target programming language can be varied; in one embodiment, source code for the Java language (made available by Oracle) is generated. This source code can be referenced by software developers to write code containing business logic relevant to what their application requires.

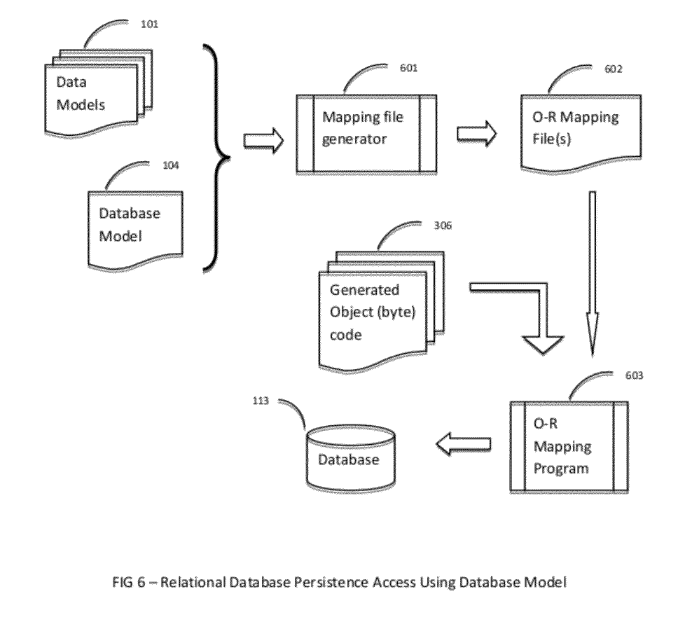

FIG. 6 shows an embodiment of Mapping File generator 601 using Data Model set 101 and Database Model 104 to generate Object-Relational (O-R) mapping files 602 for a managed entity. There are a number of software programs like Hibernate that use such files to drive persisting object-oriented classes to a relational Structured Query Language (SQL) database. Using the generated mapping files 602 and Generated Object byte-code 306, such software programs can be used for persistence.

Other generators may be used at build-time as necessary to create artifacts that can be used by the programmer, depending upon what a specific functional model needs in the system. Once all build-time generation has completed, the system is ready to be built and, subsequently installed on a computer.

In an installed system, the model files described above are made available to the application. When the application starts up, all the generators in the system are given a chance to run. Generators that need to create or modify any artifacts used at run-time will execute their corresponding operations. This allows for maximum flexibility in the system; it is possible to change certain parts of the model in an installed system and have it take effect.

Typically, a software engineering change involves a development cycle. In case of the modeling architecture, this would mean changing the model(s) at the software development location, building and releasing an updated version of the application and upgrading an existing installed system in the field. This process is very engineering-intensive, as well as disruptive to systems that need to be highly available.

If the changes from one version of an entity to another are minor, it is possible to add a new model set that defines the new version to an already running system and restart it. The system will then, when restarted, generate all the necessary artifacts and be operational with significantly reduced down time. A structure identical to the one shown in FIG. 2 in the run-time area keeps the build and runtime behavior consistent.

In one embodiment, upon system startup, for each entity type (or module), Data Model set 101 is processed and object code (corresponding to Java byte-code for the java language) 306 is generated by the Run-time Byte-code generator 502. Other artifacts, such as O-R mapping files 602 are also generated by the Mapping File Generator 601.

In an alternate embodiment, it is not even necessary to restart the running application. Using hot-deploy technologies such as those provided by Web Servers like Apache Tomcat, models for new entities (or modules) can be introduced to a running system and existing models can be updated, with the running application re-loading them and generating new artifacts as necessary.

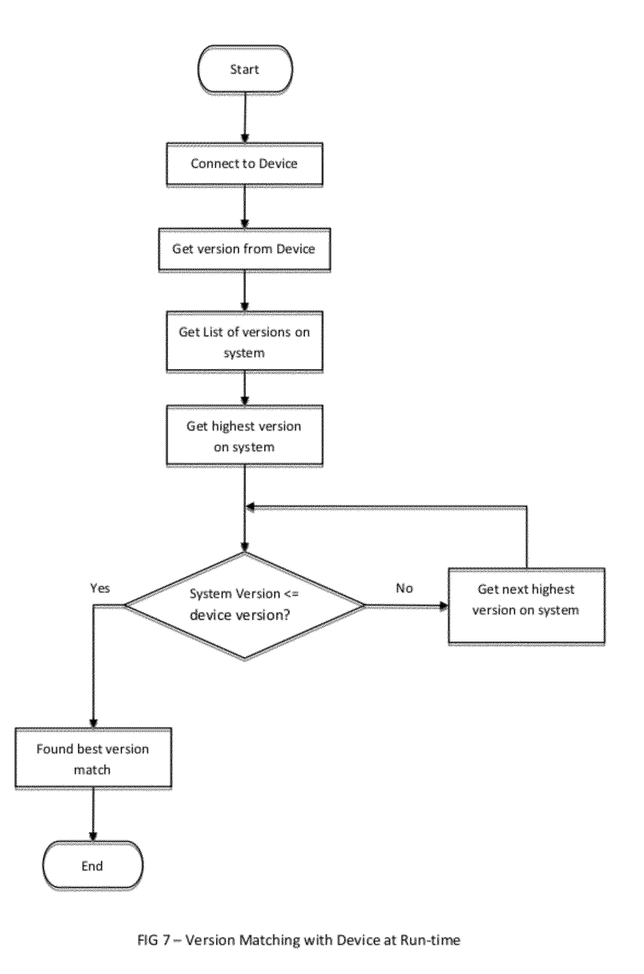

The running system holds the metadata for all entities being managed. This includes the models for every version of every entity (or device) type supported by the system. For an embodiment wherein the system manages external devices, when the system establishes communications with Device 308 for the first time, it probes Device 308 to get the current version of its data model. It then matches the model as reported by Device 308 to the closest one that it holds, using algorithm shown in FIG. 7. It then uses this match to drive software to manage the device.

In one embodiment of version numbers, models are versioned using a nomenclature such as X.Y.Z, where X, Y and Z are numbers representing a complete version. The numbers are weighted in order, with X being a major version, Y a minor version and Z a build number. In this format, version 1.2.44 is considered a lower (or older) version than 1.3.2. This is just one example of how metadata can be versioned; the system can use another format if desirable.

Using this method, the system can perform a best-effort management for devices whose models do not exactly match the versions of those contained within the system. In a configuration where a newer versioned device has been added to a system, or a device has been upgraded to a newer version, the system can still manage it on a best-effort basis using its older internal version of metadata. Once the system itself has been upgraded to contain the new version of metadata, it can provide complete management with the exact metadata version. Such a system can effectively manage any number of devices of different types concurrently, with each device potentially running against a different version of metadata.

### CONCLUSIONS, RAMIFICATIONS AND SCOPE

The flexible modeling architecture described for management has a number of advantages. First and foremost, being able to model different aspects of the system using distinct functional models, all of which can reference the data model allows a developer to exercise independent control over the system. The use of a formal, normative internal representation permits different native models to be converted to a consistent data schema representation. Doing so allows a consistent language or interface to be used between the native model developer and the developer working on the management system. It also de-couples the entity (or in some preferred embodiments, device) developers from having to worry about the models in the management system.

The ability to independently maintain separate model sets for a given entity, based upon versions provides unprecedented flexibility and resilience to changes. Treating a model set as a versioned set, it is possible to manage different versions of the entity concurrently by referring to its specific version. It allows introduction or removal of specific versions from the management system in a controlled, predictable fashion. In addition, it permits dynamic adaptation to a newer version of a managed entity at run-time and significantly eases the process of field upgrades. Using this scheme, it is also possible to automate schema upgrade activities at run-time.

The methodology of plugging in generators to permit each model to generate relevant artifacts at build-time and run-time is very useful to a developer. Source code artifacts allow the developer to write software programs that contain application (or business) logic that require access to the various models. Run-time artifacts allow a running system to be changed dynamically as new or updated models are introduced into the system.

Although the description above contains much specificity, this should not be construed as limiting the scope of the embodiment, but as merely providing one illustration of an embodiment.

It is possible to add a completely different model into the system which handles an entirely unknown aspect of the system (such as an external interface to another system)—the modeling architecture provides the mechanism to perform such additions. It is also possible to have a different model format or implementation structure to maintain the models of various versions, as long as they are maintained and accessible distinctly, an embodiment of which might be in a relational database.

Accordingly, the scope of the invention should be determined by the appended claims and not the description of the embodiment or the examples given.

We claim:

1. A flexible modeling architecture where all aspects of the data or entities being managed in a management system can be modeled using a formal definition within distinct models, independent of the underlying native technology implementation.

2. The architecture in claim 1 wherein the system can support management of any number of entity types.

3. The architecture in claim 1 wherein each entity type being managed has a plurality of models that comprise the model set for that entity.

4. The architecture in claim 1 wherein data models are used to describe the data types used to manage an entity.

5. The architecture in claim 1 wherein native models can be converted or transformed using a computer program into a formal, normative definition used throughout the system.

6. The architecture in claim 5 whereby said transformed data models can be decorated with properties that retain useful information related to the entity's native representation.

7. The architecture in claim 5 where said transformed model can be modified or enhanced by a human to perform changes to the generated formative model.

8. The architecture in claim 1 wherein other functional models that refer to said data models can be used to describe any functional aspect or perspective of the system.

9. The architecture in claim 8 wherein said functional models are clearly distinct from data models, allowing for extensibility in a structured fashion.

10. The architecture in claim 1 wherein the said models are represented in a simple format that can be easily processed by humans and machines.

11. A flexible modeling architecture that permits management of multiple different versions of different entities at the same time, distinguishing one version from another based upon their models.

12. The architecture in claim 11 wherein each version of an entity is independently described by its own set of models.

13. The architecture in claim 11 whereby said architecture can handle aspects of the system spanning multiple versions of said entity by aggregating or creating a union of all the components of each version.

14. The architecture in claim 11 wherein the system can examine metadata related to any entity or device at run-time and adapt its behavior based upon the specific version of said entity or device.

15. A flexible modeling architecture that permits generation of artifacts based upon models in order to aid the development process and run-time behavior.

16. The architecture in claim 15 wherein said models are used to generate source code and related artifacts that can be utilized by programmers at build time.

17. The architecture in claim 15 wherein said models are used to generate byte code and related artifacts that can modify system behavior at run-time.

18. The architecture in claim 17 wherein said models can be modified in a running system so as to affect said system's behavior at run-time.
